(19) United States
(12) Patent Application Publication
(10) Pub. No.: US 2004/0153631 A1
(43) Pub. Date: Aug. 5, 2004

(54) Method to handle instructions that use non-windowed registers in a windowed microprocessor capable of out-of-order execution

(76) Inventors: Chandra M. R. Thimmannagari, Fremont, CA (US); Sorin Iacobovici, San Jose, CA (US); Rabin A. Sugumar, Sunnyvale, CA (US)

Correspondence Address: OSHA & MAY L.L.P./SUN, 1221 MCKINNEY, SUITE 2800, HOUSTON, TX, 77010, US

(21) Appl. No.: 10/354,283

(22) Filed: Jan. 30, 2003

(51) Int. Cl. G06F 9/30

(52) U.S. Cl. 712/218

(57) ABSTRACT

A method for handling instructions that use non-windowed registers in an out-of-order microprocessor with windowed registers is provided. When an instruction with a non-windowed destination register is detected, the computed result of the instruction is stored in a temporary storage register instead of the non-windowed register designated as the instruction's destination. When the instruction is ready for retirement, the result is transferred from the temporary storage register into the non-windowed register designated as the instruction's destination. When another instruction's source register is a non-windowed register, the microprocessor determines whether the instruction should use data from the designated non-windowed register or from a temporary storage register, to prevent the other instruction from using incorrect data.

### BACKGROUND OF INVENTION

As shown in FIG. 1, a typical computer (100) includes a microprocessor (102), memory (104), and numerous other elements and functionalities typical of computers (not shown). The computer (100) may also include input means, such as a keyboard (106), a mouse (108), and an output device, such as a monitor (110). Those skilled in the art will understand that these input and output means may take other forms in an accessible environment.

The microprocessor (102) processes instructions provided by a computer program. A subroutine is a small piece of related code. A program may consist of one subroutine, but more commonly is composed of many subroutines. Registers are used by the microprocessor (102) to store data used by the subroutine currently being processed. A subroutine uses the registers by temporarily storing data in the registers and operating on the data stored in the registers. In a conventional microprocessor, registers are accessed using their register ID, and there are as many register IDs as there are registers.

Processors may often switch between programs, such as an operating system and an application program, or within a particular program a microprocessor may often switch between various subroutines. A switch from one program to another program is inherently also a switch from one subroutine to another subroutine.

In a conventional microprocessor, changing subroutines requires that all data in the registers (i.e., data used by the outgoing subroutine) be copied to the memory (104), and data to be used by the incoming subroutine be copied from the memory (104) into the registers. Accessing the memory (104) is typically very slow compared with the processing speed of the microprocessor (102) and the speed with which data can be stored in and retrieved from the registers. Register windowing is a technique used to allow the microprocessor (102) to more easily handle multiple subroutines. A windowed microprocessor is a microprocessor that uses register windows.

A register window is a group of registers. Each window holds data used by a subroutine. A microprocessor using windowed registers accesses the registers using a register ID and a current window pointer. The current window pointer tells the microprocessor which window the desired register is in, and the register ID defines that register's location within the specified window. When a microprocessor (102) has multiple windows, it can switch between subroutines without the time penalties associated with storing and loading from memory (104). Instead, the microprocessor (102) only needs to update the current window pointer.

FIG. 2 shows the difference between a non-windowed register file and a windowed register file. The non-windowed register file (210) is a one-dimensional array with as many register ID's as registers. The windowed register file (220) is a multi-layered structure, where the current window pointer determines which window a particular register is in, and a register ID indicates which register within the window is selected. There are fewer register IDs than registers in the windowed register file. FIG. 2 is an exemplary diagram of a windowed register file. One of ordinary skill in the art will appreciate that other topologies are possible, including a hierarchal arrangement of windows.

Some microprocessors with windowed registers have certain special purpose registers that are not windowed (e.g., 230 shown in FIG. 2). Instead, these registers exist outside the windowed register structure. In some microprocessors, these registers are not directly accessible to software programs and are only used by the microprocessor for special kinds of processing. An exemplary microprocessor of this type might have 16 general purpose registers in each of 5 register windows (a total of 80 windowed registers) and one non-windowed register for holding the partial results of a multiplication overflow or holding a portion of a dividend.

A conventional microprocessor executes instructions in program order. A microprocessor that executes instructions in program order is known as an in-order microprocessor. In-order processing can lead to inefficient use of processing resources. Sometimes a preceding instruction may take a long time to execute (e.g., if data must be loaded from memory (104)), and although a following instruction may be ready for execution, it is forced to wait for the preceding instruction to be completed. An out-of-order microprocessor is capable of allowing the following instruction to execute before the preceding instruction if the following instruction is ready to execute and the preceding instruction is not. Executing instructions in an out-of-order fashion often results in a performance increase because the resources of the microprocessor can be more efficiently used.

In order to keep the low-level details of out-of-order execution transparent to programs, out-of-order microprocessors may use in-order retirement. In an out-of-order microprocessor with in-order retirement, instructions enter the microprocessor in program order, may be executed out of program order, and the instructions' results are output in program order. In an out-of-order microprocessor with in-order retirement, an instruction is ready for retirement when the result of the instruction has been computed, the instruction has not resulted in an exception, and all other instructions preceding the instruction in program order have been retired.

Using in-order execution, if two instructions write data to a particular non-windowed register, the preceding instruction's result will be written to the non-windowed register, and the following instruction will overwrite the preceding instruction's data when the following instruction is completed. The program will “expect” the results of the following instruction to be left in the non-windowed register when the two instructions have completed, so an appropriate outcome occurs.

In a windowed microprocessor capable of out-of-order execution that has non-windowed registers, a problem can arise. Two instructions in an out-of-order microprocessor may be executed backwards with respect to program order. First, the following instruction's result is stored in the non-windowed register. Then, the result of the preceding instruction will overwrite the following instruction's result. The following instruction would write the following instruction's result to the non-windowed register, and after that, the preceding instruction would write the preceding instruction's result to the same non-windowed register. A later instruction would expect to find the following instruction's result in the non-windowed register, but the preceding instruction's result would be stored in the non-windowed register. Accordingly, fatal program errors may occur.

Conventional solutions to this problem require that all instructions in the pipeline be completed before executing an instruction that uses a non-windowed register, which is known as serializing. Serializing can degrade performance.

### SUMMARY OF INVENTION

According to one aspect of the present invention, a method for using a non-windowed register in a windowed microprocessor capable of out-of-order execution comprises computing a result of a first instruction, wherein a destination register of the first instruction is the non-windowed register; storing the result of the first instruction in a first temporary storage register; and transferring the result to the non-windowed register when the first instruction is ready for retirement.

According to one aspect of the present invention, a windowed microprocessor capable of out-of-order execution comprises a non-windowed register, wherein the non-windowed register is a destination register of a first instruction; and a first temporary storage register arranged to store a working copy of a result of the first instruction, wherein the windowed microprocessor is arranged to transfer the working copy of the result of the first instruction from the first temporary storage register to the non-windowed register when the first instruction is ready for retirement.

According to one aspect of the present invention, a windowed microprocessor capable of out-of-order execution comprises means for computing a result of a first instruction, wherein a destination register of the first instruction is a non-windowed register; means for storing the result of the first instruction in a temporary register; and means for transferring the result to the non-windowed register when the first instruction is ready for retirement.

Other aspects and advantages of the invention will be apparent from the following description and the appended claims.

### BRIEF DESCRIPTION OF DRAWINGS

FIG. 1 shows a block diagram of a prior art computer system.

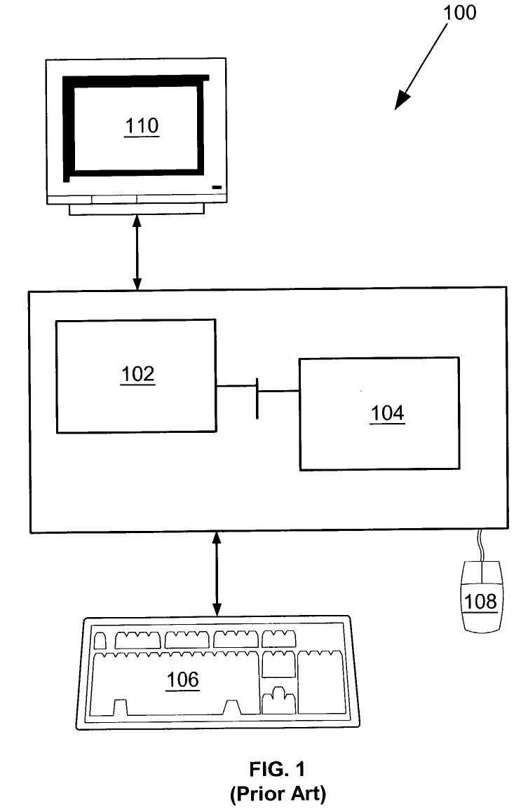

FIG. 2 shows a diagram of a windowed register file and an exemplary non-windowed register file in accordance with an embodiment of the present invention.

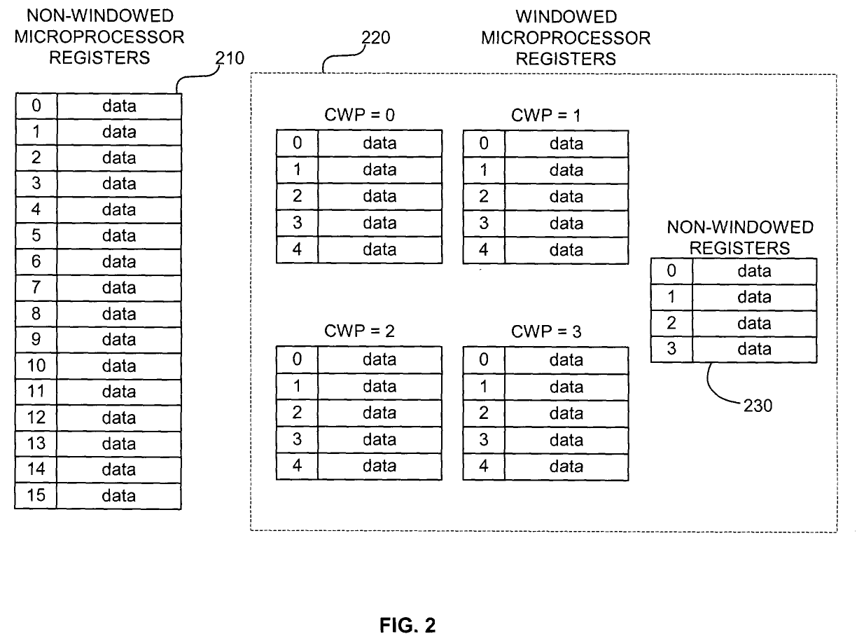

FIG. 3 shows a block diagram of an exemplary microprocessor pipeline structure in accordance with an embodiment of the present invention.

FIG. 4 shows a flow diagram in accordance with an embodiment of the present invention.

FIG. 5 shows a flow diagram in accordance with an embodiment of the present invention.

### DETAILED DESCRIPTION

Embodiments of the present invention relate to a means for handling instructions that use non-windowed registers in a windowed microprocessor capable of out-of-order execution without serializing the instructions.

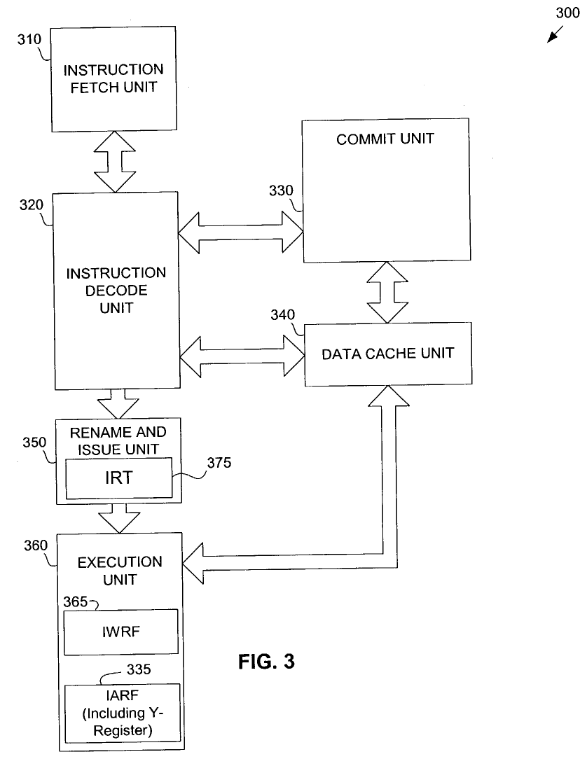

FIG. 3 shows a block diagram of an exemplary computer system pipeline (300) in accordance with an embodiment of the present invention. The computer system pipeline (300) includes an instruction fetch unit (310), an instruction decode unit (320), a commit unit (330), a data cache unit (340), a rename and issue unit (350), and an execution unit (360). Those skilled in the art will note that not all functional units of a computer system pipeline are shown in the computer system pipeline (300), e.g., a memory management unit. Any of the units (310, 320, 330, 340, 350, 360) may be pipelined or include more than one stage. Accordingly, any of the units (310, 320, 330, 340, 350, 360) may take longer than one cycle to complete a process.

The instruction fetch unit (310) is responsible for fetching instructions from memory. Accordingly, instructions may not be readily available, i.e., a memory miss occurs. The instruction fetch unit (310) performs actions to fetch the proper instructions. The instruction fetch unit (310) may fetch bundles of instructions. For example, in one or more embodiments, up to three instructions may be included in each bundle, or fetch group.

In one embodiment, the instruction decode unit (320) is divided into two decode stages (D1, D2). D1 and D2 are each responsible for partial decoding of an instruction. D1 may also flatten register fields, manage resources, kill delay slots, and determine the existence of a front end stall. Flattening a register field maps a smaller number of register bits to a larger number of register bits that maintain the identity of the smaller number of register bits and additional information such as a particular architectural register file. Flattening may be dependent on a current window pointer. A front end stall may occur if an instruction is complex, requires serialization, is a window management instruction, results in a hardware spill/fill, has an evil twin condition, or a control transfer instruction couple, i.e., has a branch in a delay slot of another branch.

A complex instruction is an instruction not directly supported by hardware and may require the complex instruction to be broken into a plurality of instructions supported by hardware. An evil twin condition may occur when executing a fetch group that contains both single and double precision floating point instructions. A register may function as both a source register of the single precision floating point instruction and as a destination register of a double precision floating point instruction, or vice versa. The dual use of the register may result in an improper execution of a subsequent floating point instruction if a preceding floating point instruction has not fully executed, i.e., committed the results of the computation to an architectural register file. D2 may also assign working IDs to instructions.

The commit unit (330) is responsible for maintaining an architectural state of the microprocessor and initiating traps as needed. The commit unit (330) maintains the architectural state primarily by retiring instructions in program order.

The data cache unit (340) is responsible for providing memory access to load and store instructions. Accordingly, the data cache unit (340) includes a data cache, and surrounding arrays, queues, and pipes needed to provide memory access.

The rename and issue unit (350) is responsible for renaming, picking, and issuing instructions. Renaming involves taking flattened instruction source registers provided by the instruction decode unit (320) and renaming the flattened instruction source registers to working registers. Renaming may start in the instruction decode unit (320). Also, the renaming determines whether the flattened instruction source registers should be read from an architectural register file or a working register file.

Picking involves monitoring an operand ready status of an instruction in an issue queue, performing arbitration among instructions that are ready, and selecting which instructions are issued to execution units. The rename and issue unit (350) may issue one or more instructions dependent on a number of execution units and an availability of an execution unit. The computer system pipeline (300) may be arranged to simultaneously process multiple instructions. Issuing instructions steers instructions selected by the picking to an appropriate execution unit. The rename and issue unit (350) may issue instructions out of order.

The execution unit (360) is responsible for executing the instructions issued by the rename and issue unit (350). The execution unit (360) may include multiple functional units such that multiple instructions may be executed simultaneously (i.e., a multi-issue microprocessor).

The execution unit (360) may include a plurality of register windows. In one embodiment, five register windows are supported. The five register windows may be used by multiple processes. A register window may pass a value to another register window dependent on a window management instruction. A current window pointer may point to an active register window. Additional information may be maintained such that the number of additional register windows that are available may be known. Furthermore, a set of register windows may be split, with each group of register windows supporting a different process (user or kernel).

In FIG. 3, each of the units (310, 320, 330, 340, 350, 360) provides processes to load, break down, and execute instructions. Resources are required to perform the processes. In an embodiment of the present invention, “resources” are any queue that may be required to process an instruction. For example, the queues include a live instruction table, issue queue, integer working register file, floating point working register file, condition code working register file, load queue, store queue, branch queue, etc. As some resources may not be available at all times, some instructions may be stalled. Furthermore, because some instructions may take more cycles to complete than other instructions, or resources may not currently be available to process one or more of the instructions, other instructions may be stalled. A lack of resources may cause a resource stall. Instruction dependency may also cause some stalls.

The present invention avoids the problems associated with non-windowed registers by maintaining working copies of data to be stored in the non-windowed register. When the execution unit has computed the results of an instruction whose destination register is non-windowed, the execution unit writes the result to a working register for temporary storage, until the instruction is retired. When the instruction is retired, the working copy of the data is copied into the non-windowed register that was the destination register of the instruction.

In an embodiment of the present invention, a microprocessor using register windows may implement a SPARC instruction set architecture. The SPARC instruction set architecture includes a Y register which is non-windowed. The Y register is used for storing the upper bits of a product of multiplication, and for storing the upper bits of the dividend in division. The following description relates to an embodiment of the present invention as applied to the Y register of a windowed microprocessor implementing the SPARC instruction set architecture. A Y-instruction is an instruction that uses the Y register as a source register or a destination register.

In an embodiment of the present invention, the microprocessor has two register files, an architectural register file (IARF) (335) and a working register file (IWRF) (365). The IARF (335) contains temporary registers, the Y register, and the register windows each containing a plurality of registers. Except for temporary registers, all registers in the IARF (335) are accessible to programs. The IWRF (365) is not directly accessible to programs, and is used by the microprocessor for internal operations and for temporary storage.

In one embodiment, an instruction decode unit (320) detects a Y-instruction which has the Y register as a destination register. The instruction decode unit assigns a working register file ID (IWRF_ID) and an architectural register file ID (IARF_ID) to the Y-instruction, then forwards the Y-instruction, IWRF_ID, and IARF_ID to the rename and issue unit (350) and to the commit unit (330).

In one embodiment, a rename and issue unit (350) updates an integer rename table (375) (IRT) by inserting the IWRF_ID of the Y-instruction into the IRT (375) using the IARF_ID of the Y-instruction as an index. The function of the IRT (375) will be described later with respect to Y-instructions which use the Y register as a source register. After updating the IRT (375), the rename and issue unit (350) writes the Y-instruction to an issue queue, where the Y-instruction waits to be issued to the execution unit (360).

The execution unit (360) computes the result of the Y-instruction and writes the result of the computation into the IWRF (365) using the IWRF_ID of the Y-instruction as an index. The execution unit (360) forwards a completion report to the commit unit (330) to let the commit unit (330) know that the Y-instruction has been executed and that the result of the Y-instruction is stored at index IWRF_ID of the IWRF.

The commit unit (330) waits for a retire pointer to indicate that the Y-instruction is ready for retirement. When the Y-instruction is ready for retirement, the commit unit (330) reads the data stored in the IWRF (365) at an index determined by the IWRF_ID of Y-instruction, which contains the result of the Y-instruction. The commit unit (330) stores the result of the Y-instruction in the IARF (335) using the IARF_ID of the Y-instruction as an index.

In one or more embodiments of the present invention, instructions are executed out of order and their results are stored as working copies in a working register file, instead of in the “true” registers, i.e., the IARF (335). Only when instructions are retired, which occurs in order, is the IARF (335) updated with the resulting values. Thus, programs that expect a particular Y-instruction's result to be stored in the Y register can know that the appropriate value is there, not the value resulting from a previous Y-instruction that was executed after the particular Y-instruction.

The embodiment described above for handling Y-destination-instructions causes a problem for Y-instructions that use the Y register as a source register (Y-source-instructions). If a Y-destination-instruction precedes a Y-source-instruction, then the Y-source-instruction expects the results of the preceding Y-destination-instruction to be stored in the Y-register when the Y-source-instruction executes. However, in one or more embodiments, the result of the preceding Y-destination-instruction may be stored only in the IWRF (365) and not yet be written to the IARF, i.e., the Y register. If the Y-source-instruction reads its source data from the Y-register, it may use the wrong source data.

In one embodiment, the rename and issue unit (350) uses the IRT (375) to keep track of where a Y-source-instruction should get its source data. In one embodiment, the IRT (375) is a one-dimensional array with as many rows as there are registers in the IARF. When a Y-destination-instruction reaches the rename and issue unit (350), the rename and issue unit (350) inserts the Y-destination-instruction's IWRF_ID into the IRT (375) at an index determined by the IARF_ID of the Y-destination-instruction. So effectively, at the index determined by the IARF_ID, the IRT (375) holds a pointer to the working copy (stored in the IWRF (365) at an index determined by the Y-destination-instruction's IWRF_ID) of the data to be stored in the Y register. When the Y-destination-instruction is retired, the Y-destination-instruction's IWRF_ID, stored at the index determined by the Y-destination-instruction's IARF_ID, is removed from the IRT (375).

When the rename and issue unit (350) receives a Y-source-instruction, the rename and issue unit consults the IRT (375) to determine from which register to retrieve the source data (i.e., data contained in the Y-source-instruction's source registers). If there is a pointer to a location in the IWRF (365) (i.e., there is a preceding Y-destination-instruction in the pipeline that has not been retired), then the rename and issue unit (350) forwards the Y-source-instruction to the execution unit, forcing the execution unit to execute the Y-source-instruction with data retrieved from the IWRF (i.e., the working copy) for the portion of the source register referring to the Y register. If there is no pointer to a location in the IWRF, then the rename and issue unit (350) forwards the Y-source-instruction to the execution unit, forcing the execution unit to execute the Y-source-instruction with data retrieved from the Y register in the IARF (335) for the portion of the source register referring to the Y register. This ensures that the Y-source-instruction is executed using appropriately updated source data.

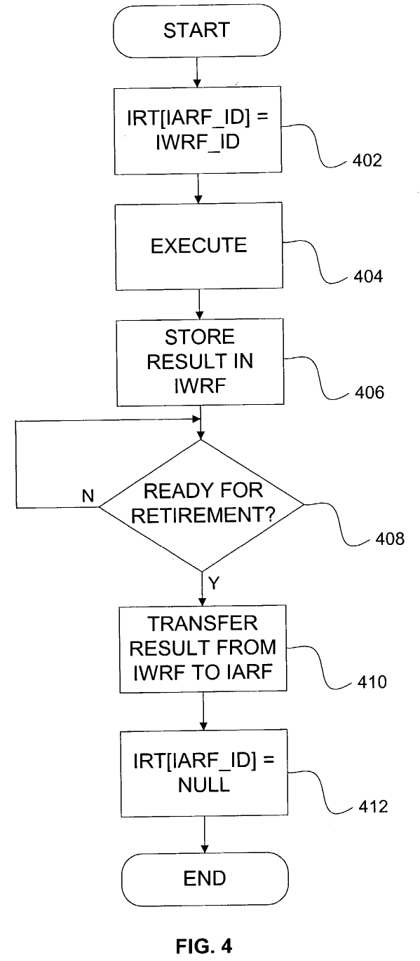

FIG. 4 shows a flow chart describing the steps involved in processing an instruction using the Y register as a destination register. In step (402), the integer rename table (IRT) is updated by inserting the instruction's IWRF_ID into the integer rename table at an index determined by the instruction's IARF_ID. At step (404) the instruction is executed. At step (406) the result of the instruction is written to the IWRF. Step (408) waits for the instruction to be ready for retirement. Once the instruction is ready for retirement, at step (410), the result is transferred from the IWRF to the IARF. Finally, in step (412), the entry in the integer rename table is cleared.

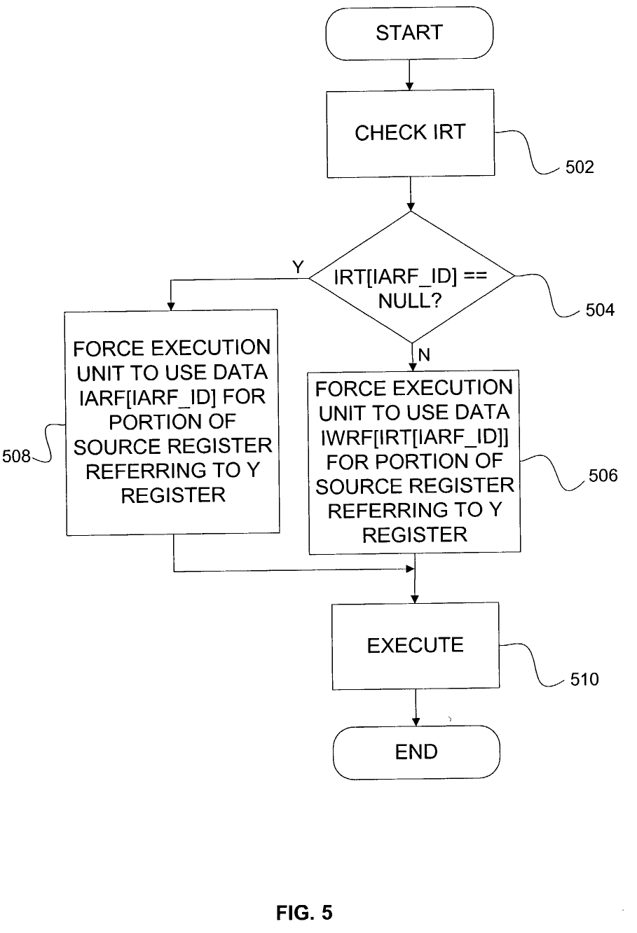

FIG. 5 shows a flow chart describing the steps involved in processing an instruction using the Y register as a source register. In step (502), the microprocessor checks the integer rename table (IRT). More specifically, in step (504), the microprocessor determines whether there is an entry in the integer rename table for the Y register. If there is an entry (i.e., if IRT[IARF_ID] is not NULL), then in step (506) the microprocessor forwards the instruction to the execution unit and forces the execution unit to get data from the IWRF for the portion of the source register referring to the Y register. Specifically, the execution unit gets data from the index in the IWRF indicated by the entry at IARF in the integer rename table (i.e., IWRF[IRT[IARF_ID]]). If there is no entry in the integer rename table for the Y register (i.e., if IRT[IARF_ID] is NULL), then in step (508) the microprocessor forwards the instruction to the execution unit and forces the execution unit to get data from the IARF for the portion of the source register referring to the Y register. In step (510) the instruction is executed using whichever source data was in step (506) or (508).

Advantages of the present invention may include one or more of the following. In one or more embodiments, the present invention may allow a windowed microprocessor capable of out-of-order execution to handle instructions that use a non-windowed register without serializing. In one or more embodiments, the present invention solves the problems associated with instructions that use a non-windowed register as a destination register. In one or more embodiments, the present invention allows a windowed microprocessor capable of out-of-order execution to handle instructions that use a non-windowed register as a source register without serializing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for using a non-windowed register in a windowed microprocessor capable of out-of-order execution, comprising:
computing a result of a first instruction, wherein a destination register of the first instruction is the non-windowed register;
storing the result of the first instruction in a first temporary storage register; and
transferring the result to the non-windowed register when the first instruction is ready for retirement.

2. The method of claim 1, further comprising:
computing a result of a second instruction, wherein a destination register of the second instruction is the non-windowed register;
storing the result of the second instruction in a second temporary storage register; and
transferring the result to the non-windowed register when the second instruction is ready for retirement.

3. The method of claim 2, wherein the first instruction and the second instruction are in a common fetch group.

4. The method of claim 1, further comprising:
detecting the first instruction in a fetch group.

5. The method of claim 1, further comprising:
assigning an ID to the first instruction.

6. The method of claim 5, wherein the assigning comprises assigning a temporary storage register ID.

7. The method of claim 1, wherein the storing comprises storing the result in a temporary storage register identified by a temporary storage register ID.

8. The method of claim 1, wherein the transferring comprises:
determining whether the first instruction is ready for retirement;
conditionally reading the result of the first instruction stored in the first temporary storage register based on the determining; and
conditionally storing the result of the first instruction in the non-windowed register based on the determining.

9. The method of claim 1, further comprising:
detecting a second instruction,
wherein a source register of the second instruction is the non-windowed register,
wherein the second instruction follows the first instruction in program order, and
wherein the first instruction has not been retired; and
computing a result of the second instruction using source data loaded from the first temporary storage register.

10. The method of claim 9, further comprising:
assigning an ID to the second instruction.

11. The method of claim 9, wherein the first instruction and the second instruction are in a common fetch group.

12. A windowed microprocessor capable of out-of-order execution, comprising;
a non-windowed register, wherein the non-windowed register is a destination register of a first instruction; and
a first temporary storage register arranged to store a working copy of a result of the first instruction, wherein the windowed microprocessor is arranged to transfer the working copy of the result of the first instruction from the first temporary storage register to the non-windowed register when the first instruction is ready for retirement.

13. The windowed microprocessor of claim 12, further comprising:
a second temporary storage register arranged to store a working copy of a result of a second instruction, wherein the non-windowed register is a destination register of the second instruction, and wherein the windowed microprocessor is arranged to transfer the working copy of the result of the second instruction from the second temporary storage register to the non-windowed register when the second instruction is ready for retirement.

14. The windowed microprocessor of claim 12, further comprising:
an instruction decode unit arranged to assign a temporary storage register ID to the first instruction.

15. The windowed microprocessor of claim 14, the instruction decode unit further arranged to forward the first instruction and the temporary storage register ID.

16. The windowed microprocessor of claim 12, further comprising:
an execution unit arranged to:
compute the result of the first instruction, and
store the result of the first instruction in the first temporary storage register.

17. The windowed microprocessor of claim 12, further comprising:
a commit unit arranged to:
make a determination as to whether the first instruction is ready for retirement,
conditionally read the result stored in the first temporary storage register based on the determination, and
conditionally store the result in the non-windowed register based on the determination.

18. The windowed microprocessor of claim 17, the commit unit further arranged to receive the first instruction and a temporary storage register ID from the instruction decode unit.

19. The windowed microprocessor of claim 12,
wherein a source register of a second instruction is the non-windowed register,
wherein the second instruction follows the first instruction in program order,
wherein the first instruction has not been retired, and
wherein a result of the second instruction is computed using the working copy of the result of the first instruction.

20. The windowed microprocessor of claim 19, further comprising:
a rename and issue unit arranged to:
determine whether the first instruction has been retired, and
force the second instruction to get data from the first temporary storage register if the first instruction has not been retired.

21. A windowed microprocessor capable of out-of-order execution, comprising:
means for computing a result of a first instruction, wherein a destination register of the first instruction is a non-windowed register;
means for storing the result of the first instruction in a temporary register; and
means for transferring the result to the non-windowed register when the first instruction is ready for retirement.

22. The windowed microprocessor of claim 21, further comprising:
means for detecting a second instruction,
wherein a source register of the second instruction is the non-windowed register,
wherein the second instruction follows the first instruction in program order, and
wherein the first instruction has not been retired; and
means for computing a result of the second instruction using source data loaded from the temporary register.
